(19) United States
(12) Patent Application Publication
(10) Pub. No.: US 2007/0234333 A1
(43) Pub. Date: Oct. 4, 2007

(54) Method for dynamically updating resource allocation statues

(75) Inventors: Huan-Chih Yu, Taipei (TW); Chi-Tsung Chang, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/391,924

(22) Filed: Mar. 28, 2006

(51) Int. Cl. G06F 9/44

(52) U.S. Cl. 717/168

(57) ABSTRACT

A method for dynamically updating system resource allocation statuses applicable to a system platform with a plurality of primary routes is proposed, which allows the OS to know the allocation and application statues of resources (e.g. memories, buses, I/O devices etc.) contained in the system platform for the primary routes. First, a data storage area is established and the resource allocations of primary routes are detected and store in the data storage area by the BIOS. Then, the data stored in the data storage area is filled into update templates for the OS to access. Accordingly, manual input is eliminated and debugging is made easy.

### FIELD OF THE INVENTION

The present invention relates to a data updating technique, and more particularly, to a method for dynamically updating resource allocation statues in related tables by obtaining the resource allocation statues via executing software before the hardware are ready.

### BACKGROUND OF THE INVENTION

Advanced Configuration and Power Interface (hereinafter ACPI) defines interfaces for the application programs of the Operating System (OS) to control all hardware components and power management. In the OS, information such as motherboard temperature, fan speed and voltage of the power supply can be detected in cooperation with the hardware in order to provide suitable power and working frequency for the host to achieve power saving and efficiency at the same time. ACPI is a power management system interface developed by Intel, Microsoft and Toshiba, which allows the OS to manage power used by peripheral devices based on certain rules, such as, if the hard disk or monitor is idle for a certain period of time, a power-saving mode is entered or operation is suspended until a user uses it again.

ACPI standard can be applied to typical desktop computers and portable computers, which puts the OS, instead of the BIOS, in control of the power usage of the computer itself and its peripheral devices. Thus, the power on/off switch of the power supply is connected to the motherboard instead of connected to the power supply. Conventionally, if the power on/off switch of the power supply is turned off, the computer stops supplying power immediately. Whereas now when a user turns off the power on/off switch, then system enters into the sleeping mode, and when the user presses the power on/off switch continuously for at least four seconds, the system is notified to perform shut down and data is appropriately arranged during this time. Meanwhile, the OS knows completely the current statuses of the system. For example, if the user is doing a presentation, the application programs will notify the monitor to function normally. In addition, there is no need to restart since the power management rules can be adjusted according to current requirements. Power management controlled by the OS eliminates the problem in storage space for power management rules as in the case of power management controlled by the OS. Hardware with the ACPI standard is more diverse than the previously existing APM model. Moreover, the ACPI standard provides a user-friendly interface for settings and management by users, in which graphic interface is often used to indicate current power usage, thus improving power management ability.

Conventionally, there is only a single primary route (HOST) between an Input/Output (I/O) chip and an X86 Central Processing Unit (CPU), thus only a static ACPI table needs to be provided to the OS. Conversely, a current AMD HyperTransport-Based CPU supports four routes. Under the traditional architecture, ACPI needs to report distributions of ACPI-defined resources for each of the routes. That is, two routes require two ACPI tables; three routes require two ACPI tables and so forth. The current approach for obtaining resource information in an ACPI table is that when the system is turned on, a user manually fills data into the ACPI table by referring to the allocations of the system resources. One drawback of this approach is that the resource allocation information is only obtained after the machine is ready and the power-on procedures has reached the DOS. Thus, the ACPI testing time is delayed, and since the information requires manual input, it is not applicable to other system platform. Moreover, each time a system platform is changed, the platform architecture and primary routes may be different, resources allocation information needs to be refilled each time testing is performed. If an error occurs in the process or the information, it is also very difficult to determine the cause of the error, wasting time and aggravating user inconveniences. Thus, there is a need for a method for acquiring resource information for various system platforms with a plurality of primary routes.

### SUMMARY OF THE INVENTION

In the light of forgoing drawbacks, an objective of the present invention is to provide a method for dynamically updating resource allocation statues to dynamically update allocation and application statues of resources contained in primary routes of a system platform, such that time is not wasted due to manual update, allowing the ACPI functions to be prepared and hardware status to be reported by software part even before the hardware are completely ready.

Another objective of the present invention is to provide a method for dynamically updating resource allocation statues that is applicable to different system platform architectures without the need to determine the number of primary routes contained in the system platform architectures, thereby improving application flexibility and convenience.

Still another objective of the present invention is to provide a method for dynamically updating resource allocation statues that facilitates users in debugging and finding causes of errors, reducing time spent in finding errors and their causes.

In accordance with the above and other objectives, the present invention provides a method for dynamically updating resource allocation statues. By executing software, a data storage area is established as an ACPI buffer to allow the BIOS and the ACPI codes that are previously incompatible with each other to exchange data in this area, such that resource allocation and application results detected by the BIOS can then be filled into ACPI tables for the OS to access. The method for dynamically updating resource allocation statues comprises the steps of: (1) establishing a data storage area; (2) allowing the BIOS to detect resource allocation and application statues contained in the primary routes during a Power On Self-Test (POST); (3) allowing the BIOS to store the result obtained in step S2 to the data storage area; (4) modifying ACPI source language code to establish a plurality of update templates; (5) filling the data in the data storage area into the corresponding update templates; and (6) allowing the OS to read the data in the update templates to know the resource allocation and application of the primary routes contained in the system platform used.

In summary, the method for dynamically updating resource allocation statues of the present invention applicable to system platforms with a plurality of primary routes is used to efficiently prepare the ACPI functions, avoiding time wasted due to manual update. The method of the present invention is also applicable to different platform architectures. Additionally, debugging is made easy. Therefore, the present invention solves the problems described in the prior art.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart illustrating the method for dynamically updating system resource allocation statuses of the present invention; and

FIG. 2 is a block diagram depicting an example of the actual implementations of the method of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

The following embodiments will be explained in details using an AMD K8 system platform as an example. The AMD K8 has four groups of PCI function, in which Function 0: HyperTransport technology configuration; Function 1: Address map configuration; Function 2: DRAM and Transport technology Trace mode configuration and Function 3: Miscellaneous configuration. The present invention is however not limited to this type of system platform.

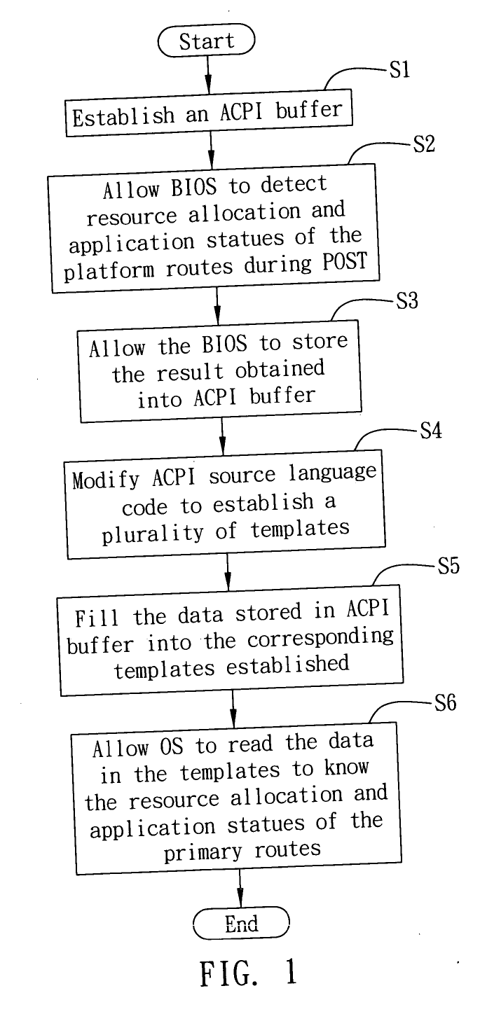

FIG. 1 is a flowchart illustrating the method for dynamically updating system resource allocation statuses of the present invention. The method for dynamically updating system resource allocation statuses of the present invention is applicable to a system platform with a plurality of primary routes (HOST), which allows to the OS to control the allocation and application of resources (e.g. memories, buses, I/O devices etc.) contained in the system platform with a plurality of primary routes.

Since there is traditionally only a single primary route between an I/O chip and an X86 CPU, thus only a static ACPI table needs to be provided to the OS. However, current system platform (e.g. AMD HyperTransport-Based platform) may support four routes. Under the traditional architecture, ACPI needs to report distributions of ACPI-defined resources for each of the routes. That is, two routes require two ACPI tables; three routes require two ACPI tables and so forth. The current approach for obtaining resource information in an ACPI table is that when the system is turned on, a user manually fills data into the ACPI table by referring to the allocations of the system resources. One drawback of this approach is that the resource allocation information is only obtained after the machine is ready and the power-on procedures has reached the DOS. Thus, the ACPI testing time is delayed, and since the information requires manual input, it is not applicable to other system platform. Moreover, each time a system platform is changed, the platform architecture and primary routes may be different, resources allocation information needs to be refilled each time testing is performed. If an error occurs in the process or the information, it is also very difficult to determine the cause of the error, wasting time and aggravating user inconveniences. In view of this, the present invention provides a method for dynamically updating resource allocation statuses of the present invention.

As shown in FIG. 1, in step S1, a data storage area is first established as an ACPI buffer so as to allow the BIOS and the ACPI codes that are previously incompatible with each other to exchange data in this area. Then, go to step S2.

In step S2, allowing the BIOS to detect resource allocation and application statues of the platform routes during a Power On Self-Test (POST). Then, go to step S3,

In step S3, allowing the BIOS to store the result obtained in step S2 into the ACPI buffer. Then, go to step S4.

In step S4, modifying ACPI source language code to establish a plurality of templates. Then, go to step S5.

In step S5, filling the data about resource allocation and application statuses of the platform routes that is stored in the ACPI buffer into the corresponding templates established in step S4 to generate ACPI tables. Then, go to step S6.

In step S6, allowing the OS to read the data in the templates after booting is completed to know the resource allocation and application of the primary routes contained in the system platform used.

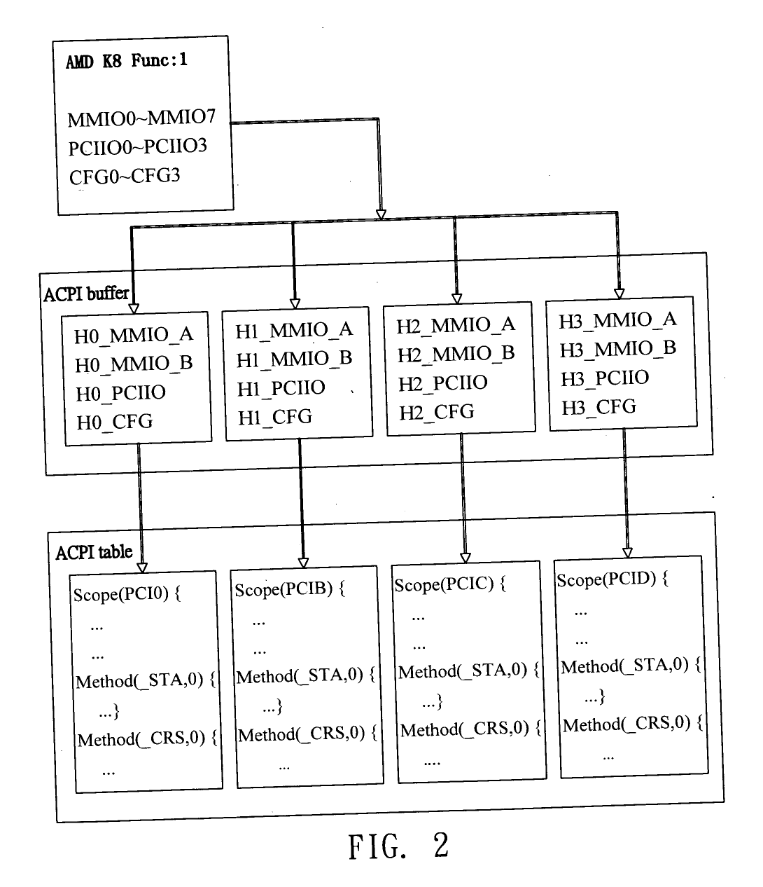

An example of the actual implementations of the above steps is shown in FIG. 2.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for dynamically updating system resource allocation statuses applicable to a system platform with a plurality of primary routes for dynamically updating allocation statues of resources contained in the primary routes, the method comprising:
(1) establishing a data storage area;
(2) allowing a Basic Input/Output System (BIOS) of the system platform to detect the resource allocations of each of the primary routes and store the result in the data storage area;
(3) establishing a plurality of update templates; and
(4) filling the data stored in the data storage area into the corresponding update templates.

2. The method for dynamically updating system resource allocation statuses of claim 1, wherein the system platform is an AMD HyperTransport Based system platform.

3. The method for dynamically updating system resource allocation statuses of claim 1, wherein there are four primary routes.

4. The method for dynamically updating system resource allocation statuses of claim 1, wherein the data storage area is used as an Advance Configuration and Power Interface (ACPI) buffer.

5. The method for dynamically updating system resource allocation statuses of claim 1, wherein, in the step (2), the BIOS detects the resource allocations of each of the primary routes during a Power On Self-Test (POST).

6. The method for dynamically updating system resource allocation statuses of claim 1, wherein the update templates are obtained by modifying the ACPI source language code.

7. The method for dynamically updating system resource allocation statuses of claim 1, wherein the step (3) further comprises allowing an Operating System (OS) to read the data in the update templates so as to know the resource allocation and application statues of the primary routes contained in the system platform.
